(19) United States
(12) Patent Application Publication
(10) Pub. No.: US 2011/0089782 A1
(43) Pub. Date: Apr. 21, 2011

(54) ROTOR FOR ELETROMOTOR USING PERMANENT MAGNETS

(76) Inventor: Young-Chun JEUNG, Cypress, CA (US)

(21) Appl. No.: 12/644,741

(22) Filed: Dec. 22, 2009

(30) Foreign Application Priority Data
Oct. 19, 2009 (KR) 10-2009-0099280

(51) Int. Cl. H02K 21/14; H02K 5/24

(52) U.S. Cl. 310/156.46; 310/51

(57) ABSTRACT

A rotor for an electromotor using permanent magnets is provided. The rotor may include one or more C-type permanent magnets, a core, and a rotor shaft. Each of the one or more C-type permanent magnets may have a C shape and provide magnetic force. The core may be of a cylindrical shape and have the one or more C-type permanent magnets coupled thereto with different magnetic poles. An aperture 11 may be formed at each of the boundaries of the C-type permanent magnets having the different magnetic poles. The rotor shaft may be formed at the center of the core. Cogging torque can be reduced because a magnetic field of the C-type permanent magnets coupled through the outside core forms a normal sine wave form.

### CROSS-REFERENCE TO RELATED APPLICATION(S)

This application claims the benefit under 35 U.S.C. §119(a) of a Korean Patent Application No. 10-2009-0099280, filed on Oct. 19, 2009, in the Korean Intellectual Property Office, the entire disclosure of which is incorporated herein by reference for all purposes.

### BACKGROUND

1. Field

The following description relates to a rotor for an electromotor using permanent magnets, and more particularly, to a rotor for a high-capacity and high-output brushless motor using high-characteristic permanent magnets, which may be capable of reducing cogging and noise of the rotor.

2. Description of Related Art

In general, the rotor of permanent magnets may be configured to generate mechanical rotation torque through a reciprocal operation with the rotating magnetic field of an armature. A rotor system may be irregular, or a magnetic field distribution of the rotor may not be ideal, such as a sine wave. This may result from several causes, such as the coupling structure of a rotor core and permanent magnet bodies, a magnetizing pattern, the magnetic poles of the armature, and slot structures, for example. Accordingly, cogging torque may be generated and vibration and noise may be generated in the motor.

In particular, a high-capacity and high-power brushless motor may include a rotor using high-characteristic permanent magnets having a high energy density. However, there may be a problem in that cogging torque, vibration, and noise may become profound in a high-capacity and high-output motor having a smaller air gap between the armature and the rotor.

Here, the high-characteristic permanent magnet may refer to a permanent magnet with a high magnetic energy density, such as an alnico, neodymium (Nd)-series or samarium cobalt (SmCo)-series magnet having a surface magnetic flux of 1 Kgauss or more, for example. Such a high-characteristic permanent magnet may be difficult for radial magnetization in a centrifugal direction or magnetic pole anisotropic magnetization although they are of a type, such as a C-type permanent magnet, for a rotor. The permanent magnet may not form an ideal sine wave or a conical magnetic field, may have low efficiency through a reaction to the rotating magnetic field of the armature because of distortion, and may generate cogging torque, rotating vibration, and noise.

A conventional rotor for permanent magnets, as shown in FIG. 1, may include C-type permanent magnet bodies formed in parallel to maintain a circumferential diameter Ro around the center 6 and each configured to have a predetermined thickness. The C-type permanent magnet bodies having alternating S poles 2 and N poles 3 may be adhered to a surface Ri of a rotor core 1. The rotor core 1 may be made of a magnetic material and is configured to have a center hole 5 into which a rotor shaft may be inserted.

In the rotor in which the C-type permanent magnet bodies may be adhered to the rotor core 1 made of a ferromagnetic material as described above, the permanent magnet bodies may form magnetic fields 4 through the rotor core 1. However, as shown in FIG. 2, a distribution of the magnetic fields of the permanent magnet bodies may not form an ideal sine wave magnetic field and has depressed dual peaks 3′ and 4′ at the tip of each of the magnetic poles.

If the conventional permanent magnet rotor drives a motor with it being coupled with the armature, it generates pieces of cogging torque 3′ and 4′ because of severe rotor-series curves that may be generated by an interaction with the armature poles as shown in FIG. 3.

In the case where the magnetic body is magnetized using uniform magnetic particles so that it has a predetermined thickness d1 and a predetermined length L as shown in FIG. 4, other problems may arise. In particular, a magnetic field distribution 90 having two peaks may be formed as a result of the intensity of a magnetic field that is in inverse proportion to the square of a distance from an opposite pole in the case of a flat-type magnet body 7. As a result, a magnetic field 80 may be severely distorted in the case of a C-type magnet body 8 for a rotor having a circumference having a predetermined thickness d2, an inside diameter Ri, and an outside diameter Ro.

To address these drawbacks, in a conventional rotor for ferrite C-type permanent magnets, branch powders may be arranged in the radial direction or anisotropically, sintered, and magnetized in a manufacturing process. However, such a magnetic arrangement and magnetizing method may not be convenient for a high-characteristic alnico, Nd, or SmCo-series magnet formed through casting. Accordingly, a problem may arise in that, if the magnetic arrangement and magnetizing method described above is used to manufacture a motor rotor using magnets, the above-described drawbacks remain.

### SUMMARY

In one general aspect there is provided a rotor for an electromotor using permanent magnets. The rotor may include one or more C-type permanent magnets, each permanent magnet configured to have a C shape and provide magnetic force, a core configured to have a cylindrical shape and having the one or more C-type permanent magnets coupled thereto with different magnetic poles, wherein an aperture is formed in the core at each of boundaries of the C-type permanent magnets having the different magnetic poles, and a rotor shaft formed at a center of the core.

Each of the C-type permanent magnets may have an outer circumferential face having two or more different outside radii and centrifugal axes, a same inside diameter as the centrifugal axis of a real circle, and a predetermined length L and a predetermined width W.

The core may include an outside core configured to have a cylindrical shape and have the one or more C-type permanent magnets with the different magnetic poles coupled to an outside of the outside core, the aperture being formed at each of the boundaries of the C-type permanent magnets in the outside core, and an inside core configured to have a cylindrical shape and formed within the outside core, the rotor shaft being formed at a center hole of the inside core.

The aperture may have either a circular or elliptical section and a size of the aperture may be controlled according to a magnetic characteristic of the C-type permanent magnets and a magnetic design of the motor.

The inside core may be made of rubber or a silicon material and may be configured to have a honeycomb-shaped sound absorption and dustproof structure.

Each of the C-type permanent magnets may include a neodymium (Nd)-series or samarium cobalt (SmCo)-series magnet having a surface magnetic flux of 1 Kgauss or more.

The outside radius (Ra) at one location of the C-type permanent may be equal to the outside radius (Rc) at another location of the C-type permanent magnet, and the outside radius (Rc) at a third location of the C-type permanent magnet is not equal to the outside radii Ra, Rb.

The aperture formed in the outside core at each of the boundaries of the C-type permanent magnets may be formed with an opening such that the aperture communicates with an area radially outside of the outside core.

In another aspect, a rotor for an electromotor is provided. The rotor may include a core having an outside core and an inside core positioned radially within the outside core, a plurality of C-type permanent magnets coupled to an outer circumference of the outside core and extending about the circumference of the outside core, wherein a boundary is formed between each individual C-type permanent magnet of the plurality of C-type permanent magnets, and a plurality of apertures formed in the outside core, each aperture formed at a position corresponding to the boundary between each C-type permanent magnet.

An outer radius of each C-type permanent magnet may vary along the circumference of the C-type permanent magnet.

Other features and aspects will be apparent from the following detailed description, the drawings, and the claims.

### BRIEF DESCRIPTION OF THE DRAWINGS

FIG. 1 is a cross-sectional view of a conventional rotor for an electromotor using permanent magnets.

FIG. 2 is a diagram showing a sine wave of the conventional rotor for an electromotor using permanent magnets shown in FIG. 1.

FIG. 3 is a diagram showing cogging torque of the conventional rotor for an electromotor using permanent magnets shown in FIG. 1.

FIG. 4 is a diagram showing the shape of a sine wave according to the permanent magnets in the conventional rotor for an electromotor using the permanent magnets shown in FIG. 1.

FIG. 5A is a perspective view of a rotor for an electromotor using permanent magnets according to an embodiment.

FIG. 5B is a diagram showing the shape of the sine wave corresponding to the permanent magnets according to an embodiment.

FIG. 6A is a cross-sectional view of a core of the rotor for an electromotor using permanent magnets according to the embodiment shown in FIG. 5.

FIG. 6B is a perspective view of the core of the rotor for an electromotor using permanent magnets according to the embodiment shown in FIG. 5.

FIG. 7A is a perspective view of the permanent magnet of the rotor for an electromotor using permanent magnets according to the embodiment shown in FIG. 5.

FIG. 7B is a perspective view showing the dimensions of the permanent magnet of the rotor for an electromotor using permanent magnets according to the embodiment shown in FIG. 5.

FIG. 8 is a cross-sectional view of a magnetic characteristic of the permanent magnets in the rotor for an electromotor using permanent magnets according to the embodiment shown in FIG. 5.

FIG. 9 is a diagram showing a sine wave characteristic of the rotor for an electromotor using permanent magnets according to the embodiment shown in FIG. 5.

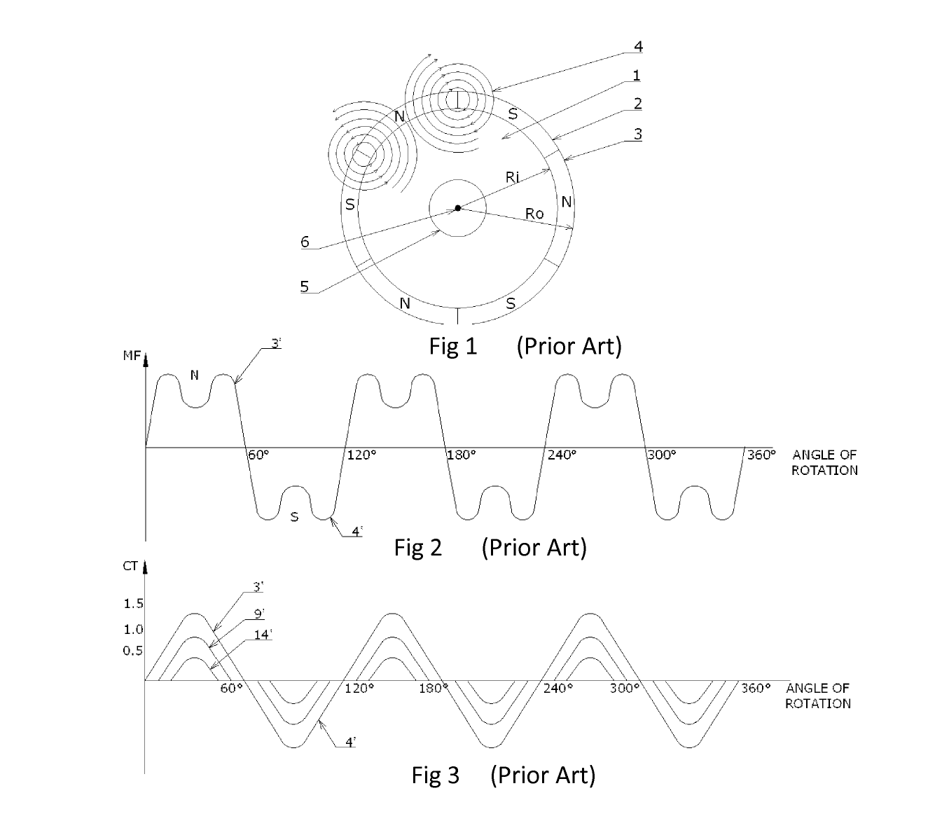

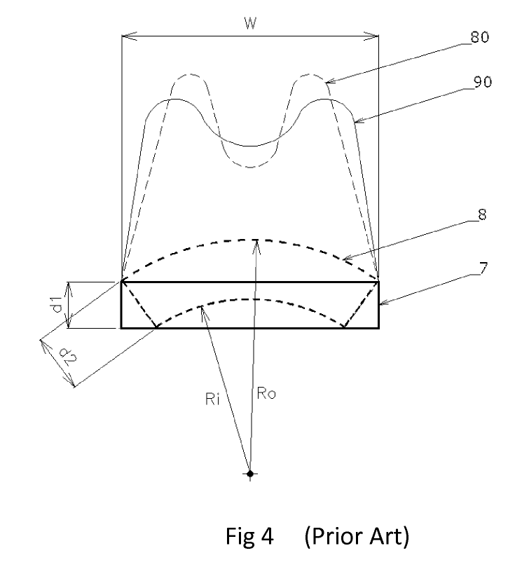

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

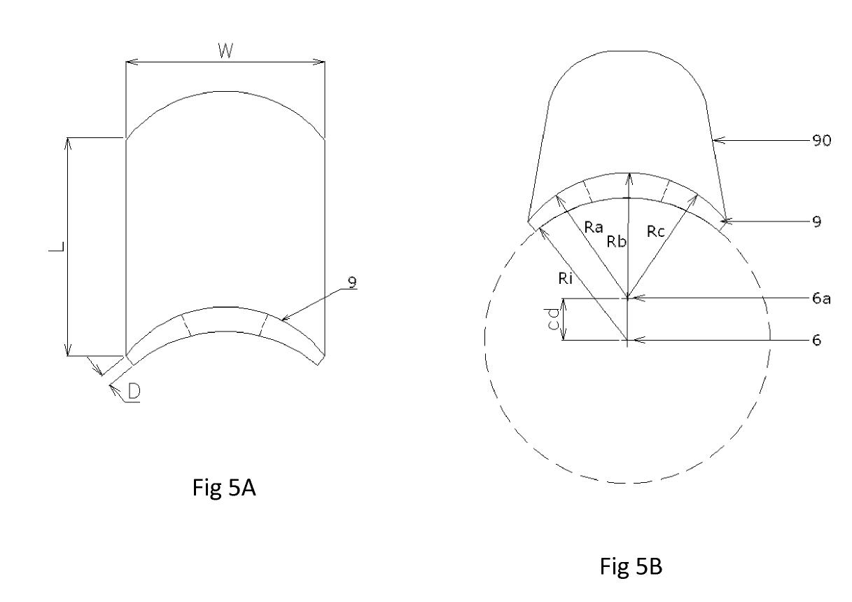

FIG. 5A is a perspective view of a rotor for an electromotor using permanent magnets. A permanent magnet may have a predetermined length L, a predetermined width W, and a thickness D.

FIG. 5B is a diagram showing a magnetic field distribution 90 in the form of a sine wave, which corresponds to the permanent magnets of the exemplary embodiment. The permanent magnet 9 includes inner and outer circumferential faces. The outer circumferential face may include two or more outer radii. For example, as shown in FIG. 5B, the outer circumferential face 14 may include two radii which are equal, Ra and Rc, and another, different radius, Rb.

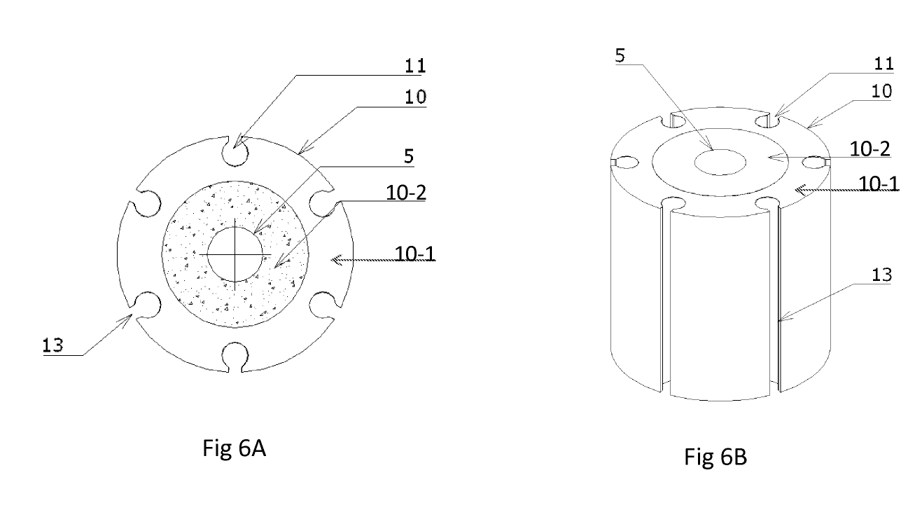

FIG. 6A is a cross-sectional view of a core of the rotor for an electromotor using permanent magnets. FIG. 6B is a perspective view of the core of the rotor for an electromotor using permanent magnets. Referring to these figures, apertures 11 may be formed in an outside core 10-1. Each aperture 11 may include an opening 13 positioned along the circumference of the outside core 10-1.

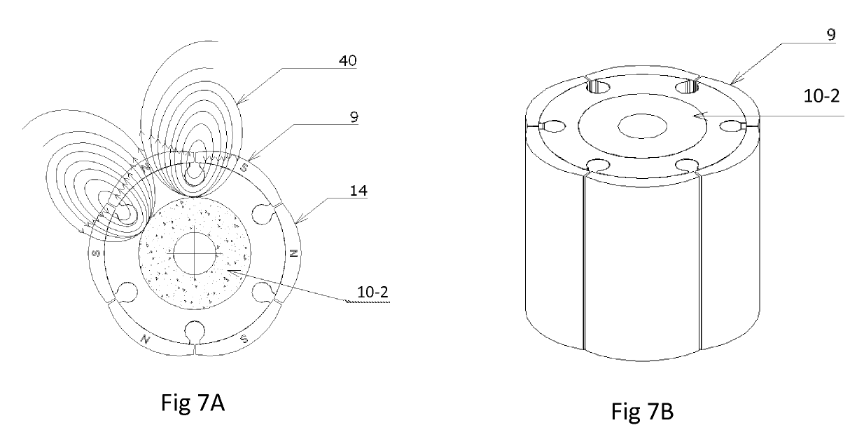

FIG. 7A is a perspective view of the permanent magnet of the rotor for an electromotor using permanent magnets, showing a generated magnetic field 40. FIG. 7B is a perspective view showing the dimensions of the permanent magnet of the rotor for an electromotor using permanent magnets.

Referring to FIGS. 5-7 and 9, the rotor for an electromotor using permanent magnets may include one or more C-type permanent magnets 9, a core 10 having the outside core 10-1 and an inside core 10-2, apertures 11, and a rotor shaft 15.

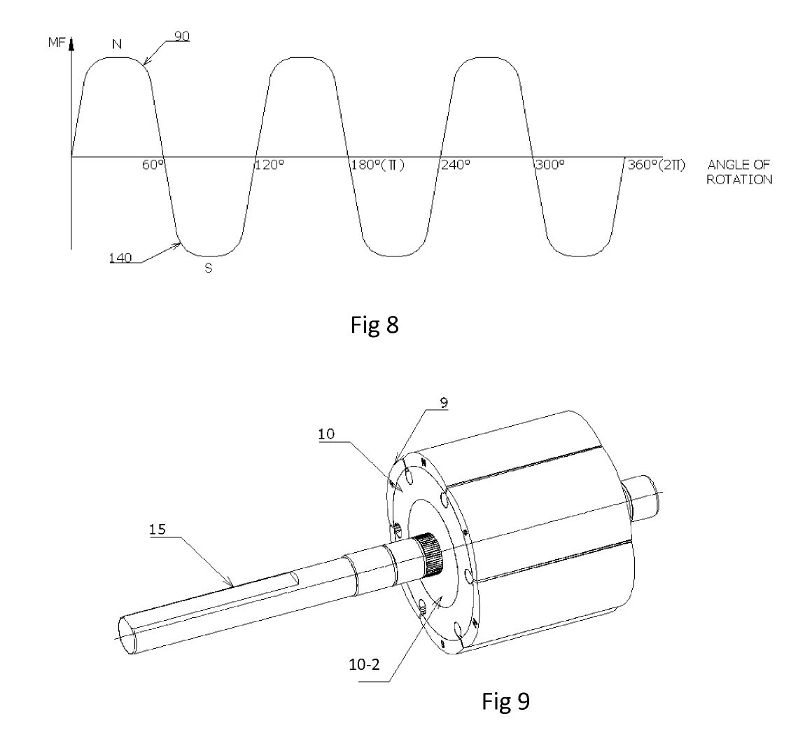

The outer circumferential face 14 of each of the C-type permanent magnets 9 may have two or more different outside radii. For example, among radii Ra, Rb, and Rc, each corresponding to a different location along the circumference of a magnet, Ra may be equal to Rb and Rc may be different from Ra and Rb. Centrifugal axes 6 and 6a may also have the same inside diameter Ri as the centrifugal axis 6 of a real circle and a predetermined length L and a predetermined width W. When coupling, for example, the two C-type permanent magnets 9 with the outside core 10-1, the magnets may have different magnetic poles as shown in FIG. 8. In this case, the boundary between the C-type permanent magnets 9 may be placed at each of the apertures 11 of the outside core 10-1.

When coupling the one or more C-type permanent magnets 9 with the outside core 10-1, the C-type permanent magnets 9 have different magnetic poles on the basis of the boundary therebetween, and the boundary may be placed at each of the apertures 11. The inside core 10-2 may be configured to have a cylindrical shape and is formed within the outside core 10-1. The rotor shaft 15 may be formed at the center of the inside core 10-2.

The apertures 11 may function to increase a magnetic path between the boundaries of the magnetic poles of the C-type permanent magnets 9 to the maximum extent and to shorten a central passage of a magnetic field. Thus, although the C-type permanent magnets are adhered to the outside core 10-1, a distribution of magnetic fields may not be distorted, and an ideal sine wave magnetic field may be formed.

Furthermore, the apertures 11 may have various sizes. The shape or size of the apertures 11 may be determined according to a magnetic characteristic or a core design of the C-type permanent magnet. For example, the apertures 11 may be circular or elliptical.

Through the above exemplary configurations, as shown in FIG. 8, for example, magnetic fields of the C-type permanent magnets 9 may revolve around the respective apertures 11 and form magnetic passages toward their centers. Accordingly, an ideal sine wave magnetic field in which a magnetic field at the boundary between the magnetic poles is weak and a magnetic field at the central portion of each magnetic pole is strong may be formed. That is, when a sine wave magnetic field, such as that shown in FIG. 8, is formed, cogging torque may be reduced by about 30% as compared to a conventional rotor having a distorted magnetic field.

Furthermore, the inside core 10-2 may made of a non-magnetic material. Accordingly, cogging torque and vibration applied to the rotating shaft 15 may be reduced by about 60 to 70%.

As described above, the rotor for an electromotor using the permanent magnets may be advantageous in that it may reduce cogging torque because magnetic fields of the C-type permanent magnets coupled with the outside core may form an ideal sine wave magnetic field.

Furthermore, the inside core may be made of rubber or a silicon material, for example, and include a porous sound absorption/dustproof structure having a honeycomb shape. However, the inside core is not limited to these materials or configurations. Accordingly, there may be an advantage in that cogging torque and vibration transferred to the rotating shaft may be reduced.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A rotor for an electromotor using permanent magnets, comprising:
one or more C-type permanent magnets, each permanent magnet configured to have a C shape and provide magnetic force;
a core configured to have a cylindrical shape and having the one or more C-type permanent magnets coupled thereto with different magnetic poles, wherein an aperture is formed in the core at each of boundaries of the C-type permanent magnets having the different magnetic poles; and
a rotor shaft formed at a center of the core.

2. The rotor as claimed in claim 1, wherein each of the C-type permanent magnets has an outer circumferential face having two or more different outside radii and centrifugal axes, a same inside diameter as the centrifugal axis of a real circle, and a predetermined length L and a predetermined width W.

3. The rotor as claimed in claim 1, wherein the core comprises:
an outside core configured to have a cylindrical shape and have the one or more C-type permanent magnets with the different magnetic poles coupled to an outside of the outside core, the aperture being formed at each of the boundaries of the C-type permanent magnets in the outside core; and
an inside core configured to have a cylindrical shape and formed within the outside core, the rotor shaft being formed at a center hole of the inside core.

4. The rotor as claimed in claim 1, wherein:
the aperture has either a circular or elliptical section, and
a size of the aperture is controlled according to a magnetic characteristic of the C-type permanent magnets and a magnetic design of the motor.

5. The rotor as claimed in claim 3, wherein the inside core is made of rubber or a silicon material and is configured to have a honeycomb-shaped sound absorption and dustproof structure.

6. The rotor as claimed in claim 1, wherein each of the C-type permanent magnets includes a neodymium (Nd)-series or samarium cobalt (SmCo)-series magnet having a surface magnetic flux of 1 Kgauss or more.

7. The rotor as claimed in claim 2, wherein the outside radius (Ra) at one location of the C-type permanent is equal to the outside radius (Rc) at another location of the C-type permanent magnet, and the outside radius (Rc) at a third location of the C-type permanent magnet is not equal to the outside radii Ra, Rb.

8. The rotor as claimed in claim 3, wherein the aperture formed in the outside core at each of the boundaries of the C-type permanent magnets is formed with an opening such that the aperture communicates with an area radially outside of the outside core.

9. A rotor for an electromotor comprising:
a core including an outside core and an inside core positioned radially within the outside core;
a plurality of C-type permanent magnets coupled to an outer circumference of the outside core and extending about the circumference of the outside core, wherein a boundary is formed between each individual C-type permanent magnet of the plurality of C-type permanent magnets; and
a plurality of apertures formed in the outside core, each aperture formed at a position corresponding to the boundary between each C-type permanent magnet.

10. The rotor of claim 9 wherein an outer radius of each C-type permanent magnet varies along the circumference of the C-type permanent magnet.
